(19) United States
(12) Patent Application Publication
(10) Pub. No.: US 2009/0000470 A1
(43) Pub. Date: Jan. 1, 2009

(54) Method of Producing a Piston for an Internal Combustion Engine and Piston for an Internal Combustion Engine

(76) Inventors: Simon Reichstein, Nurnberg (DE); Lothar Hofmann, Neumarkt (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/996,758

(22) PCT Filed: Jun. 26, 2006
(86) PCT No.: PCT/EP2006/006262

§ 371 Date: Jul. 21, 2008

(30) Foreign Application Priority Data
Jul. 26, 2005 (DE) 10 2005 034 905.6

(51) Int. Cl. F16J 1/00; B23P 15/10

(52) U.S. Cl. 92/260; 29/888.04

(57) ABSTRACT

The invention relates to a method of producing a piston (1) with a combustion chamber recess (2) for an internal combustion engine, in which at least one region of the combustion chamber recess (2) comprising at least one recess base (20) is melt-treated in order to re-melt a material in the melt-treated region, so that a buildup of the material in the melt-treated region is changed in a layer with a definable depth, and relates to such a piston (1).

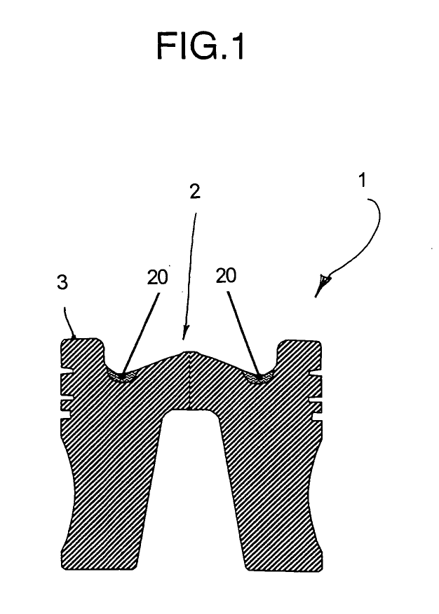

### FIELD OF THE INVENTION

The invention relates to a method of producing a piston with a combustion chamber recess for an internal combustion engine and such a piston for an internal combustion engine.

During operation in internal combustion engines, pistons are constantly subject to changes in operating conditions. Every start and/or stop procedure, and every change in load, leads to a great change in temperature distribution in the piston. These changes in temperature distribution cause internal stresses which can lead to plastic deformation and finally to failure of the piston.

### PRIOR ART

It is known to extend the life of a piston by means of material processing.

It is known from DE-OS 20 27 649 to apply a light alloy reinforcement to piston elements exposed to particular thermal and/or mechanical load, by application welding with the formation of a mixed zone. The piston, in particular in the region of a recess edge, is coated in this regard with a pure aluminium layer welded on and forming a mixed zone.

DE 199 02 864 A1 describes a piston in which the edge of the combustion chamber recess is at least partly formed by means of deposition coating of an additive material.

DE 103 35 843 A1 discloses extending the life of the piston by remelting the recess edge.

Tests however show that particular operating conditions nonetheless can lead to failure of the piston.

### PRESENTATION OF THE INVENTION

The invention is based on the object of creating a method of producing an engine piston and an engine piston by means of which the life and operating reliability of an engine piston are further increased.

This object is solved by the subject matter with the features of claims 1 and 10.

In this regard, in a method of producing a piston with a combustion chamber recess for an internal combustion engine, an area of the combustion chamber recess comprising at least one recess base is melt-treated so that a build-up of the material in the melt-treated region is changed in a layer with a definable depth. The material in the melt-treated region is “remelted”. The material in the melt-treated layer thus comprises a structure changed in relation to the underlying piston material, for example a changed particle size, giving a finer structure. The finer structure is more resistant to a changing load. The depth of the layer is in this regard suitably defined. It can range from a few μm to some mm. The depth is defined such that a build-up of the material is changed.

By remelting, failure of the piston in the recess base is countered for example because of changes in the temperature distribution, so that the life of the piston is extended.

Tools used for melt treatment are where applicable suitably adapted to the geometry of the recess base.

Preferably the region is heated by means of arc welding processes, laser and/or electron beam, and/or remelted by inductive heating. However, other forms of energy application are conceivable.

In a further preferred embodiment, the region is heated by the application of energy with a power of between 2 and 8 kW. A depth of the melt-treated layer can be influenced by the power of the energy beam and/or action time.

Preferably the melt-treated region is then cooled with a cooling rate or speed 100-1000 K/s. In technical remelt processes, hardening rates are possible in an extremely wide range, namely between around 10³ and 10⁻¹⁰ K/s. The higher the cooling rate, the finer the particle crystallisation in the melt. Within this wide range, the cooling rate of 100-1000 K/s has proved particularly favourable for pistons with a silicon proportion. Values above or below this rate can however be applied at least for pistons without silicon proportion.

In tests for pistons with silicon proportion, it has been found that the following advantages are achieved by a cooling rate of 100-1000 K/s. In the produced pistons, in the melted and subsequently cooled regions of the recess base, particles are found which are smaller, mostly clearly smaller, than 10⁻⁶ m. It has been found that particles with such a size lead to the desired dispersion hardening and hence to a clear improvement in the high temperature strength.

The preferred cooling rate of 100-1000 K/s was determined as follows. Tests revealed that the cooling rate must be at least 100 K/s in order for a sufficient proportion of the primary silicon—which may be present in the piston to be produced—to be formed sufficiently finely to allow a dispersion hardening of the material. A slower hardening would lead to a coarser structure which does not have the desired properties. Thus 100 K/s can be specified as a minimum cooling rate for particular piston materials.

With regard to the preferred upper limit of the cooling rate, a value of 1000 K/s has been found by suitable tests. With faster cooling, in pistons with a silicon proportion, a forced dissolution of the silicon in the supersaturated aluminium mixed crystals could occur. The desired fine dispersoids would then be lost. These are necessary for the desired dispersion hardening and high temperature strength. In addition, it is extremely expensive to cool those volumes of the recess base which are melted on production of the piston according to the invention, more quickly than at the cooling rate according to the invention of 1000 K/s. In total by the method according to the invention, an economically sensible production method for pistons is found with which a piston can be produced with a high temperature strength that is improved at least in regions.

Preferably the method according to the invention is used to process during its production a piston consisting of an alloy. The alloy comprises a main alloy element and at least one further alloy element. Furthermore as part of the invention it was found that the resistance to thermal fatigue can be improved by introduction of the main alloy element. This embodiment differs from the approaches previously conventionally selected in this point. In conventional methods usually strength-increasing elements are added, such as e.g. silicon, nickel, copper or magnesium. Such alloy elements for example increase the strength locally in a piston made of an aluminium alloy. It was always assumed in this regard that by an increase in strength-enhancing alloy elements, the properties relating to resistance to temperature change could also be improved. As part of the invention however it was found surprisingly that it is not an increase but a reduction in the concentration of these strength-enhancing elements that is advantageous. So the alloy is “diluted”. This measure can also be described as de-alloying. This is achieved in that the main alloy element is introduced at least to a slight extent such that the concentration of alloy elements in the treated regions is reduced, at least not increased. Tests have shown that this can indeed lead to a slight reduction in strength. However, it gives an improved resistance to thermomechanical fatigue. In particular because the method according to the invention is applied only in the regions under particular thermal stress, a piston is produced which in total only has a slightly diminished strength. The thermal load-bearing capacity is however increased in regions at particular risk, so that overall a clearly improved life of the piston results.

The effect according to the invention can be achieved in that the main alloy element is introduced in pure form as an additive. The same effect can however be achieved in that an alloy is introduced which contains the main alloy element and at least one alloy element of the piston alloy which however is present in the additive in a lower concentration than in the piston to be treated. In this manner too the concentration of the alloy element is reduced in regions and the thermal resistance of the piston increased at least in this region. In relation to the embodiment last described of the method according to the invention, in which by means of a welding process during remelting the main alloy element is added as an additive, it must be emphasised that this method step is in principle independent of other features of the invention, in particular the specified cooling rate. In other words, with any arbitrary method of producing a piston, an improvement in heat resistance can be achieved in that the piston is melted at least in regions by means of a welding process and the main alloy element is introduced as an additive so that the concentration of the main alloy element is increased at least in regions. With such a method, all other features cited above and below can advantageously be achieved. This applies in the same way to the piston according to the invention, which at least in regions can have a finer structure and increased concentration of the main alloy element in comparison with other regions, without particles being present in the size given below for the piston according to the invention. The features of the piston according to the invention can also be combined with each other in the manner described herein.

Preferably the piston is remelted in a layer with a depth of more than 200 μm, in particular at least 300 μm. This achieves a change in the structure of the material.

Preferably the piston is treated and/or processed additionally on the surface after remelting. The remelting process is thus not always the last processing step. Further processing steps, for example for smoothing the surface, can follow.

In a further embodiment, in addition to the recess base, an adjacent region is melt-treated. In principle it is conceivable to subject the entire combustion chamber recess to remelt treatment. Low hardening rates are however achieved amongst other things in that a melt-treated region is spatially limited. If a larger area is to be remelted, treatment in several steps is preferred.

The object cited above is further solved by a piston for an internal combustion engine wherein the piston has a combustion chamber recess, the combustion chamber recess is melt-treated in a region comprising at least the recess base, and a material is remelted in the melt-treated region so that a build-up of the material in the melt-treated region is changed compared with the untreated regions of the remaining piston in a layer with a definable depth. An expected life of a piston with remelted recess base is substantially longer than that of conventional pistons.

Preferably the material structure in the melt-treated region changes in a layer with a depth of more than 200 μm, in particular more than 300 μm.

In a further embodiment the piston in the melt-treated region has a finer structure than in untreated regions of the piston, preferably with particles smaller than 10⁻⁶ m.

The piston is preferably designed as a diesel piston. Diesel pistons, in particular truck pistons, are exposed to particular thermal loads. Reinforcement of the piston base by remelting is particularly advantageous here.

### BRIEF DESCRIPTION OF THE DRAWING

The invention is now explained below as an example with reference to a preferred embodiment. The only FIGURE shows:

a schematic cross-section view of a piston with reinforced recess base.

### DETAILED DESCRIPTION OF AN EMBODIMENT OF THE INVENTION

The FIGURE shows schematically a piston 1 of an internal combustion engine with a combustion chamber recess 2. The transition between piston base 3 and combustion chamber recess 2 is called the recess edge. The base of the combustion chamber recess 2 is called a recess base 20.

The recess base 20 is at least partly remelted. The remelting preferably takes place by an arc welding method. The surface of the piston 1 is melted by the arc in the region of the recess base 20. A subsequent hardening rate is many times higher than when casting the piston 1. As a result, the structure in the remelted region of the recess base 20 is finer than in the remainder of the piston 1.

1. Method of producing a piston with a combustion chamber recess for an internal combustion engine, in which at least one region of the combustion chamber recess comprising at least a recess base is melt-treated so that a build-up of the material in the melt-treated region is changed in a layer with a definable depth.

2. Method according to claim 1, wherein the region is heated by means of at least one of arc, laser, electron beam or inductive heating.

3. Method according to claim 1, wherein the region is heated by energy application with a power between 2 and 8 kW.

4. Method according to claim 1, wherein after the melt treatment, cooling takes place at a rate of 100-1000 K/s.

5. Method according to claim 1, wherein the piston consists of an alloy with a main alloy element and at least one alloy element, and that in the melt treatment the main alloy element is introduced as an additive.

6. Method according to claim 1, wherein the melt-treated region is remelted in a layer with a depth of more than 200 μm.

7. Method according to claim 6, wherein the melt-treated region is remelted in a layer with a depth of at least 300 μm.

8. Method according to claim 1, wherein after remelting, the melt-treated region is treated additionally at the surface.

9. Method according to claim 1, wherein the melt-treated region also comprises the region adjacent to the base (16).

10. Piston for an internal combustion engine, comprising: a combustion chamber recess, the combustion chamber recess in one region comprising at least one recess base which is melt-treated so that a build-up of the material in the melt-treated region is changed in comparison with the material of the untreated regions of the piston in a layer with a definable depth.

11. Piston for an internal combustion engine according to claim 10, the material structure in the melt-treated region is changed in comparison with the material of the untreated regions of the piston in a layer with a depth of more than 200 μm.

12. Piston for an internal combustion engine according to claim 11, wherein the material structure in the melt-treated region is changed in comparison with the material of the untreated regions of the piston in a layer with a depth of at least 300 μm.

13. Piston for an internal combustion engine according to claim 10, wherein the melt-treated region also comprises the region adjacent to the recess base.

14. Piston for an internal combustion engine according to claim 10, wherein in the melt-treated region, in comparison with the untreated regions of the piston, particles are present with a finer structure, with a size smaller than 10⁻⁶ m.

15. Piston for an internal combustion engine according to claim 10, fabricated from an alloy consisting of a main alloy element and at least one alloy element, and that at least in the melt-treated region there is a higher concentration of the main alloy element.

16. Piston according to claim 15, wherein the main alloy element is aluminium or iron.

17. Piston according to claim 10, comprising a diesel piston.
